(19) United States
(12) Patent Application Publication
(10) Pub. No.: US 2011/0141406 A1
(43) Pub. Date: Jun. 16, 2011

(54) LOW COLOR VARIATION OPTICAL DEVICES AND BACKLIGHT MODULES AND LIQUID CRYSAL DISPLAYS COMPRISING THE OPTICAL DEVICES

(75) Inventors: Ying-Jui Lin, Kaohsiung City (TW); Hui-Lung Kuo, Taipei City (TW); Ping-Chen Chen, Taipei City (TW); Mei-Chih Peng, Taoyuan County (TW); Yi-Ping Hsieh, Changhua County (TW)

(73) Assignee: Industrial Technology Research Institute, Hsinchu (TW)

(21) Appl. No.: 12/757,826

(22) Filed: Apr. 9, 2010

(30) Foreign Application Priority Data
Dec. 14, 2009 (TW) TW98142684

(51) Int. Cl. G02F 1/1347

(52) U.S. Cl. 349/75

(57) ABSTRACT

A low color variation optical device is provided. The optical device includes a cholesteric liquid crystal film, a first phase retardation film disposed above the cholesteric liquid crystal film and a second phase retardation film disposed below the cholesteric liquid crystal film, wherein the second phase retardation film includes a plurality of molecules with a tilted and twisted arrangement. The invention also provides a backlight module and a liquid crystal display including a low color variation optical device.

### CROSS REFERENCE TO RELATED APPLICATIONS

This Application claims priority of Taiwan Patent Application No. 098142684, filed on Dec. 14, 2009, the entirety of which is incorporated by reference herein.

### BACKGROUND OF THE INVENTION

1. Field of the Invention

The invention relates to a low color variation optical device, and more particularly to an optical device capable of compensating for color variation and a backlight module and a liquid crystal display comprising the optical device.

2. Description of the Related Art

In recent years, liquid crystal displays have successfully substituted for CRTs and become the most important display devices. Various bottlenecks in conventional technology, for example brightness, color, contrast and response rate, have been progressively improved. However, some demands, for example reduced energy consumption and environmental protection are new issues. In a liquid crystal displays, polarized light is generated by disposing an absorptive polarizer. However, light-harvesting efficiency of such liquid crystal displays is low due to loss of up to 50% or more of non-polarized light which is absorbed by the polarizer. To improve brightness and energy efficiency of displays, a brightness enhancing film (BEF) is utilized to convert the original non-polarized light absorbed by the polarizer into polarized light able to pass through the absorptive polarizer. Theoretically, 100% of the light can pass through the polarizer without loss, this substantially improves the light-harvesting efficiency of the liquid crystal display.

Conventional brightness enhancing films comprise light-collecting type brightness enhancing films and light-polarized type brightness enhancing films. The latter is the only optical film which can improve both brightness and energy-saving. The light-polarized type brightness enhancing films are divided into a composite brightness enhancing film formed of a cholesteric liquid crystal and a ¼ phase difference plate and a multiple-layered brightness enhancing film formed of stacked polymer films with specific birefringence characteristics. Both the composite brightness enhancing film and the multiple-layered brightness enhancing film convert non-polarized light into polarized light which is able to pass through a down polarizer. Additionally, a part of polarized light that cannot penetrate the down polarizer is reflected back to the bottom reflector with diffusion and scrambling characteristics of the backlight module and converted into polarized light which can then penetrate the down polarizer. Thus, most of the light is converted into effective light, substantially enhancing the brightness of the LCD module.

A backlight module is a critical element in liquid crystal displays. Also, a brightness enhancing film is an important element of the backlight module. The multiple-layered brightness enhancing film is formed of stacked optical materials with various refractive indexes to separate light into linearly polarized light which can then penetrate the polarizer, and another linearly polarized light which cannot penetrate the polarizer but is then recycled and reflected back out to achieve enhanced brightness. The multiple-layered brightness enhancing film is held by the top down technology. Using a cholesteric liquid crystal to separate light into left and right circularly polarized light in order to enhance brightness is held by the bottom up technology. However, the cholesteric liquid crystal brightness enhancing film may produce inherent color variation when viewed from a large viewing angle.

Multiple-layered brightness enhancing film technologies, for example U.S. Pat. No. 6,107,364 and the cholesteric liquid crystal brightness enhancing film technology, for example U.S. Pat. No. 6,088,079, U.S. Pat. No. 6,721,030, U.S. Pat. No. 6,879,356 and U.S. Pat. No. 6,669,999 disclose using cholesteric liquid crystals capable of separating polarized light to prepare brightness enhancing films. The transflective LCD with such brightness enhancing films improves cost and light-harvesting efficiency and achieves twice the brightness of the original display in theory.

The brightness enhancing film structures disclosed by U.S. Pat. No. 6,099,758 of Merck Corporation, U.S. Pat. No. 5,731,886 of Rockwell Corporation and U.S. Pat. No. 6,342,934 of Nitto Corporation comprise a cholesteric liquid crystal compensation film capable of compensating for color variation to achieve brightness enhancement and color variation reduction. The above-mentioned cholesteric liquid crystal compensation films are disposed on the surface of the cholesteric liquid crystal layer toward the panel. Such compensation films are directed to compensate penetrated polarized light. Additionally, repeated film pasting is therefore required.

In U.S. Pat. No. 6,630,974, Reveo Co., Ltd. discloses a wide color gamut cholesteric liquid crystal brightness enhancing film with infrared gamut cholesteric liquid crystal (c-plate) pasted on the upper and lower surfaces thereof to modify elliptically polarized light.

### BRIEF SUMMARY OF THE INVENTION

One embodiment of the invention provides a low color variation optical device comprising a cholesteric liquid crystal film, a first phase retardation film disposed above the cholesteric liquid crystal film and a second phase retardation film disposed below the cholesteric liquid crystal film, wherein the second phase retardation film comprises a plurality of molecules with a tilted and twisted arrangement.

The disclosed optical device comprises one cholesteric liquid crystal film capable of separating an incident light into a left circularly polarized light and a right circularly polarized light. The circularly polarized light unable to pass through the cholesteric liquid crystal film is then reflected therefrom and the polarization configuration of the reflected light is further altered by the second phase retardation film capable of compensating for color variation disposed below the cholesteric liquid crystal film. Finally, the color variation of the light emitted from the cholesteric liquid crystal film is then adjusted.

One embodiment of the invention provides a backlight module comprising a light source, a light guide plate disposed on one side of the light source, a reflector disposed below the light guide plate, an optical device disposed above the light guide plate and a polarizer disposed above the optical device, wherein the optical device comprises a cholesteric liquid crystal film, a first phase retardation film disposed above the cholesteric liquid crystal film and a second phase retardation film disposed below the cholesteric liquid crystal film, wherein the second phase retardation film comprises a plurality of molecules with a tilted and twisted arrangement.

One embodiment of the invention provides a backlight module comprising a light source, a reflector disposed above the light source, an optical device disposed above the reflector and a polarizer disposed above the optical device, wherein the optical device comprises a cholesteric liquid crystal film, a first phase retardation film disposed above the cholesteric liquid crystal film and a second phase retardation film disposed below the cholesteric liquid crystal film, wherein the second phase retardation film comprises a plurality of molecules with a tilted and twisted arrangement.

The backlight module with enhanced brightness, low color variation, wide viewing angle and simple fabrication is composed of a combination of the optical device capable of compensating for color variation of polarized light reflected from the cholesteric liquid crystal film, the light source and the reflector.

The second phase retardation film (color variation compensation film) comprising the molecules with a tilted angle and self-twist arrangement or with an optical configuration of a-plate, c-plate or o-plate is disposed below the cholesteric liquid crystal film departed from the panel to compensate for the color variation of the polarized light reflected from the cholesteric liquid crystal film. Additionally, the second phase retardation film is integrated on the side toward the light source of the cholesteric liquid crystal film by direct coating without repeated film pasting and an additional alignment film, effectively simplifying fabrication. In the invention, due to disposition of the first and second phase retardation films on the both sides of the cholesteric liquid crystal film, the cholesteric liquid crystal film is protected from scraping during assembling and deterioration under poor environments.

One embodiment of the invention provides a liquid crystal display comprising a liquid crystal display panel and a backlight module disposed below the liquid crystal display panel, wherein the backlight module comprises a light source, a light guide plate disposed on one side of the light source, a reflector disposed below the light guide plate, an optical device disposed above the light guide plate and a polarizer disposed above the optical device, wherein the optical device comprises a cholesteric liquid crystal film, a first phase retardation film disposed above the cholesteric liquid crystal film and a second phase retardation film disposed below the cholesteric liquid crystal film, wherein the second phase retardation film comprises a plurality of molecules with a tilted and twisted arrangement.

One embodiment of the invention provides a liquid crystal display comprising a liquid crystal display panel and a backlight module disposed below the liquid crystal display panel, wherein the backlight module comprises a light source, a reflector disposed above the light source, an optical device disposed above the reflector and a polarizer disposed above the optical device, wherein the optical device comprises a cholesteric liquid crystal film, a first phase retardation film disposed above the cholesteric liquid crystal film and a second phase retardation film disposed below the cholesteric liquid crystal film, wherein the second phase retardation film comprises a plurality of molecules with a tilted and twisted arrangement.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawing, wherein:

FIG. 1 is a cross-sectional view of a liquid crystal display with an edge-lighting backlight module according to an embodiment of the invention.

FIG. 2 shows a molecule arrangement in the second phase retardation film of the invention.

FIG. 3 is a cross-sectional view of a liquid crystal display with a bottom-lighting backlight module according to an embodiment of the invention.

FIGS. 4a and 4b show color variation of an optical device (with cholesteric liquid crystal film/liquid crystal material) according to an embodiment of the invention.

FIGS. 5a and 5b show color variation of an optical device (with cholesteric liquid crystal film/liquid crystal material) according to an embodiment of the invention.

FIGS. 6a and 6b show color variation of an optical device (with cholesteric liquid crystal film/liquid crystal material (o-plate)) according to an embodiment of the invention.

FIGS. 7a and 7b show color variation of an optical device (with cholesteric liquid crystal film/first liquid crystal material (o-plate)/second liquid crystal material (o-plate)) according to an embodiment of the invention.

FIGS. 8a and 8b show color variation of an optical device (with cholesteric liquid crystal film/liquid crystal material (o-plate)) according to an embodiment of the invention.

FIGS. 9a and 9b show color variation of an optical device (with cholesteric liquid crystal film/first liquid crystal material (o-plate)/second liquid crystal material (o-plate)) according to an embodiment of the invention.

FIGS. 10a and 10b show color variation of an optical device (with cholesteric liquid crystal film/liquid crystal material (o-plate)) according to an embodiment of the invention.

FIGS. 11a and 11b show color variation of an optical device (with cholesteric liquid crystal film/first liquid crystal material (o-plate)/second liquid crystal material (o-plate)) according to an embodiment of the invention.

FIGS. 12a and 12b show color variation of an optical device (with cholesteric liquid crystal film/first liquid crystal material (o-plate)/second liquid crystal material (o-plate)/third liquid crystal material (o-plate)) according to an embodiment of the invention.

FIGS. 13a and 13b show color variation of an optical device (with cholesteric liquid crystal film/first liquid crystal material (o-plate)/second liquid crystal material (o-plate)) according to an embodiment of the invention.

FIGS. 14a and 14b show color variation of a conventional optical device (with cholesteric liquid crystal film).

FIGS. 15a and 15b show a comparison of color variation between the disclosed optical device and a conventional optical device.

FIG. 16 shows a relationship between incident angle of light and phase difference while light enters the optical device (with cholesteric liquid crystal film/second phase retardation film) according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

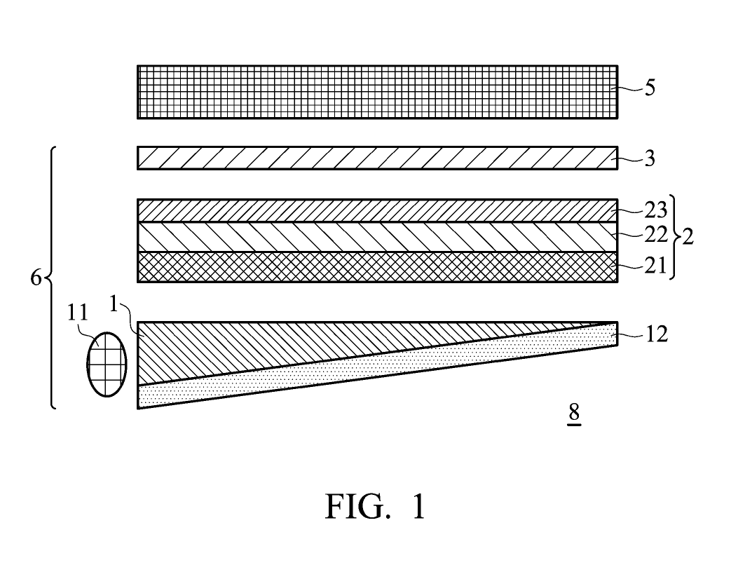

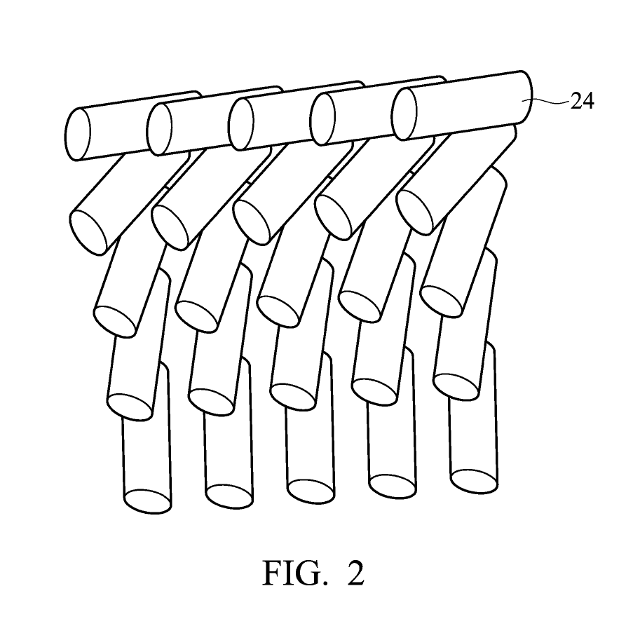

Referring to FIG. 1, an optical device according to an embodiment of the invention is provided. The optical device 2 comprises a cholesteric liquid crystal film 22, a first phase retardation film 23 and a second phase retardation film 21. The first phase retardation film 23 is disposed above the cholesteric liquid crystal film 22. The second phase retardation film 21 is disposed below the cholesteric liquid crystal film 22. Specifically, the second phase retardation film 21 comprises a plurality of molecules 24 with a tilted and twisted arrangement, as shown in FIG. 2.

The first phase retardation film 23 may be a ¼ wavelength phase retardation film, with a plane phase difference of about 100-210 nm, preferably 110-150 nm.

The molecules 24 arranged in the second phase retardation film 21 may comprise liquid crystal molecules or monomers. The molecules 24 are arranged in the second phase retardation film 21 with a tilted angle of about 1-89° or 1-45°. The molecules 24 are arranged in the second phase retardation film 21 with a twisted angle of about 1-360° or 1-90°. The molecules 24 are arranged in the second phase retardation film 21 with a tilted and twisted configuration. The optical configuration of the second phase retardation film 21 may comprise a-plate, c-plate or o-plate. The thickness of the second phase retardation film is about 0.1-20 μm.

While light enters the optical device with the cholesteric liquid crystal film integrated with the second phase retardation film, light with various incident angles generates various phase differences, as shown in FIG, 16. Such an optical phenomenon results from an asymmetric arrangement of the molecules. Thus, it is confirmed that the arrangement of the molecules 24 in the second phase retardation film 21 is tilted and twisted.

In the optical device 2, the second phase retardation film 21 may be in direct contact with the cholesteric liquid crystal film 22 or pasted on the cholesteric liquid crystal film 22 through an optical gel layer (not shown).

The disclosed optical device comprises one cholesteric liquid crystal film capable of separating an incident light into a left circularly polarized light and a right circularly polarized light. The circularly polarized light is unable to pass through the cholesteric liquid crystal film and is then reflected therefrom and the polarization configuration of the reflected light is further altered by the second phase retardation film capable of compensating for color variation disposed below the cholesteric liquid crystal film. Finally, the color variation of the light emitted from the cholesteric liquid crystal film is then adjusted.

Referring to FIG. 1, a backlight module according to an embodiment of the invention is provided. The backlight module 6 comprises a light source 11, a light guide plate 1, a reflector 12, an optical device 2 and a polarizer 3. The light guide plate 1 is disposed on one side of the light source 11. The reflector 12 is disposed below the light guide plate 1. The optical device 2 is disposed above the light guide plate 1. The polarizer 3 is disposed above the optical device 2. The optical device 2 comprises a cholesteric liquid crystal film 22, a first phase retardation film 23 and a second phase retardation film 21. The first phase retardation film 23 is disposed above the cholesteric liquid crystal film 22. The second phase retardation film 21 is disposed below the cholesteric liquid crystal film 22. Specifically, the second phase retardation film 21 comprises a plurality of molecules 24 with a tilted and twisted arrangement, as shown in FIG. 2. According to FIG. 1, the backlight module 6 is an edge-lighting backlight module.

The light source 11 of the backlight module 6 may comprise one or numerous cold cathode fluorescent lamps (CCFL) or light-emitting diodes.

In the backlight module 6, the first phase retardation film 23 of the optical device 2 may be a ¼ wavelength phase retardation film, with a plane phase difference of about 100-210 nm, preferably 110-150 nm. The molecules 24 arranged in the second phase retardation film 21 may comprise liquid crystal molecules or monomers. The molecules 24 are arranged in the second phase retardation film 21 with a tilted angle of about 1-89° or 1-45°. The molecules 24 are arranged in the second phase retardation film 21 with a twisted angle of about 1-360° or 1-90°. Indeed, the molecules 24 are arranged in the second phase retardation film 21 with a tilted and twisted configuration. The optical configuration of the second phase retardation film 21 may comprise a-plate, c-plate or o-plate. The thickness of the second phase retardation film is about 0.1-20 μm or 0.1-10 μm. In the optical device 2, the second phase retardation film 21 may be in direct contact with the cholesteric liquid crystal film 22 or pasted on the cholesteric liquid crystal film 22 through an optical gel layer (not shown).

The polarizer 3 of the backlight module 6 may be an absorptive polarizer.

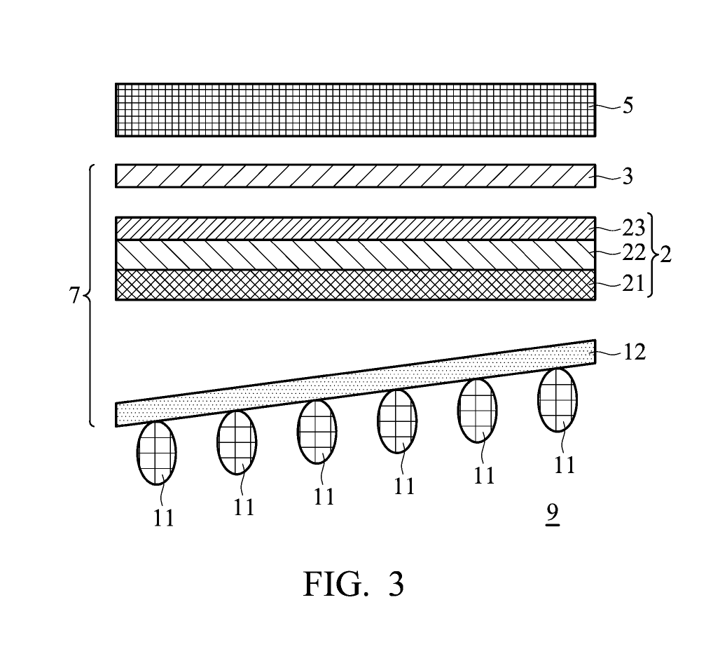

Referring to FIG. 3, a backlight module according to an embodiment of the invention is provided. The backlight module 7 comprises a light source 11, a reflector 12, an optical device 2 and a polarizer 3. The reflector 12 is disposed above the light source 11. The optical device 2 is disposed above the reflector 12. The polarizer 3 is disposed above the optical device 2. The optical device 2 comprises a cholesteric liquid crystal film 22, a first phase retardation film 23 and a second phase retardation film 21. The first phase retardation film 23 is disposed above the cholesteric liquid crystal film 22. The second phase retardation film 21 is disposed below the cholesteric liquid crystal film 22. Specifically, the second phase retardation film 21 comprises a plurality of molecules 24 with a tilted and twisted arrangement, as shown in FIG. 2. According to FIG. 3, the backlight module 7 is a bottom-lighting backlight module.

The light source 11 of the backlight module 7 may comprise one or numerous cold cathode fluorescent lamps (CCFL) or light-emitting diodes.

In the backlight module 7, the first phase retardation film 23 of the optical device 2 may be a ¼ wavelength phase retardation film, with a plane phase difference of about 100-210 nm, preferably 110-150 nm. The molecules 24 arranged in the second phase retardation film 21 may comprise liquid crystal molecules or monomers. The molecules 24 are arranged in the second phase retardation film 21 with a tilted angle of about 1-89° or 1-45°. The molecules 24 are arranged in the second phase retardation film 21 with a twisted angle of about 1-360° or 1-90°. Indeed, the molecules 24 are arranged in the second phase retardation film 21 with a tilted and twisted configuration. The optical configuration of the second phase retardation film 21 may comprise a-plate, c-plate or o-plate. The thickness of the second phase retardation film is about 0.1-20 μm or 0.1-10 μm. In the optical device 2, the second phase retardation film 21 may be directly contacted with the cholesteric liquid crystal film 22 or pasted on the cholesteric liquid crystal film 22 through an optical gel layer (not shown).

The polarizer 3 of the backlight module 7 may be an absorptive polarizer.

The backlight module with enhanced brightness, low color variation, wide viewing angle and simple fabrication is composed of a combination of the optical device capable of compensating for color variation of polarized light reflected from the cholesteric liquid crystal film, the light source and the reflector.

The second phase retardation film (color variation compensation film) comprising the molecules with a tilted angle and self-twist arrangement or with an optical configuration of a-plate, c-plate or o-plate is disposed below the cholesteric liquid crystal film departed from the panel to compensate for the color variation of the polarized light reflected from the cholesteric liquid crystal film. Additionally, the second phase retardation film is integrated on the side toward the light source of the cholesteric liquid crystal film by direct coating without repeated film pasting and an additional alignment film which effectively simplifies fabrication. In the invention, due to disposition of the first and second phase retardation films on the both sides of the cholesteric liquid crystal film, the cholesteric liquid crystal film is protected from scraping during assembling and deterioration under environmental stress.

Referring to FIG. 1, a liquid crystal display according to an embodiment of the invention is provided. The liquid crystal display 8 comprises a liquid crystal display panel 5 and a backlight module 6. The backlight module 6 is disposed below the liquid crystal display panel 5. The backlight module 6 comprises a light source 11, a light guide plate 1, a reflector 12, an optical device 2 and a polarizer 3. The light guide plate 1 is disposed on one side of the light source 11. The reflector 12 is disposed below the light guide plate 1. The optical device 2 is disposed above the light guide plate 1. The polarizer 3 is disposed above the optical device 2. The optical device 2 comprises a cholesteric liquid crystal film 22, a first phase retardation film 23 and a second phase retardation film 21. The first phase retardation film 23 is disposed above the cholesteric liquid crystal film 22. The second phase retardation film 21 is disposed below the cholesteric liquid crystal film 22. Specifically, the second phase retardation film 21 comprises a plurality of molecules 24 with a tilted and twisted arrangement, as shown in FIG. 2. According to FIG. 1, the backlight module 6 is an edge-lighting backlight module.

The light source 11 of the backlight module 6 may comprise one or numerous cold cathode fluorescent lamps (CCFL) or light-emitting diodes.

In the backlight module 6, the first phase retardation film 23 of the optical device 2 may be a ¼ wavelength phase retardation film, with a plane phase difference of about 100-210 nm, preferably 110-150 nm. The molecules 24 arranged in the second phase retardation film 21 may comprise liquid crystal molecules or monomers. The molecules 24 are arranged in the second phase retardation film 21 with a tilted angle of about 1-89° or 1-45°. The molecules 24 are arranged in the second phase retardation film 21 with a twisted angle of about 1-360° or 1-90°. Indeed, the molecules 24 are arranged in the second phase retardation film 21 with a tilted and twisted configuration. The optical configuration of the second phase retardation film 21 may comprise a-plate, c-plate or o-plate. The thickness of the second phase retardation film is about 0.1-20 μm or 0.1-10 μm. In the optical device 2, the second phase retardation film 21 may directly contact the cholesteric liquid crystal film 22 or be pasted on the cholesteric liquid crystal film 22 through an optical gel layer (not shown).

The polarizer 3 of the backlight module 6 may be an absorptive polarizer.

Referring to FIG. 3, a liquid crystal display according to an embodiment of the invention is provided. The liquid crystal display 9 comprises a liquid crystal display panel 5 and a backlight module 7. The backlight module 7 is disposed below the liquid crystal display panel 5. The backlight module 7 comprises a light source 11, a reflector 12, an optical device 2 and a polarizer 3. The reflector 12 is disposed above the light source 11. The optical device 2 is disposed above the reflector 12. The polarizer 3 is disposed above the optical device 2. The optical device 2 comprises a cholesteric liquid crystal film 22, a first phase retardation film 23 and a second phase retardation film 21. The first phase retardation film 23 is disposed above the cholesteric liquid crystal film 22. The second phase retardation film 21 is disposed below the cholesteric liquid crystal film 22. Specifically, the second phase retardation film 21 comprises a plurality of molecules 24 with a tilted and twisted arrangement, as shown in FIG. 2. According to FIG. 3, the backlight module 7 is a bottom-lighting backlight module.

The light source 11 of the backlight module 7 may comprise one or numerous cold cathode fluorescent lamps (CCFL) or light-emitting diodes.

In the backlight module 7, the first phase retardation film 23 of the optical device 2 may be a ¼ wavelength phase retardation film, with a plane phase difference of about 100-210 nm, preferably 110-150 nm. The molecules 24 arranged in the second phase retardation film 21 may comprise liquid crystal molecules or monomers. The molecules 24 are arranged in the second phase retardation film 21 with a tilted angle of about 1-89° or 1-45°. The molecules 24 are arranged in the second phase retardation film 21 with a twisted angle of about 1-360° or 1-90°. Indeed, the molecules 24 are arranged in the second phase retardation film 21 with a tilted and twisted configuration. The optical configuration of the second phase retardation film 21 may comprise a-plate, c-plate or o-plate. The thickness of the second phase retardation film is about 0.1-20 μm or 0.1-10 μm. In the optical device 2, the second phase retardation film 21 may be directly contacted with the cholesteric liquid crystal film 22 or pasted on the cholesteric liquid crystal film 22 through an optical gel layer (not shown).

The polarizer 3 of the backlight module 7 may be an absorptive polarizer.

A light path through a liquid crystal display with an edge-lighting backlight module is illustrated with FIG. 1. Light from the light source 11 enters the optical device 2 through the light guide plate 1. The optical device 2 comprises the first phase retardation film 23 (¼ wavelength phase retardation film), the cholesteric liquid crystal film 22 and the second phase retardation film 21 (color variation compensation film). While light enters the cholesteric liquid crystal film 22, the incident light is separated into a left circularly polarized light and a right circularly polarized light. While the direction of the optical rotation of the circularly polarized light is opposite to the rotation direction of the spiral cholesteric liquid crystal, the circularly polarized light passes through the cholesteric liquid crystal film 22 and then enters the first phase retardation film 23. However, while the direction of optical rotation of the circularly polarized light is the same as the direction of rotation of the spiral cholesteric liquid crystal, the circularly polarized light is reflected from the cholesteric liquid crystal film 22. The reflected light passes through the second phase retardation film 21 and is then reflected back to the second phase retardation film 21 by the reflector 12. The second phase retardation film 21 is utilized to adjust the polarization configuration of the reflected light. Finally, the light passes through the first phase retardation film 23, the absorptive polarizer 3 and the liquid crystal display panel 5.

### EXAMPLE 1

Fabrication of the Optical Device I and the Backlight Module Comprising the Same

Fabrication of the Optical Device I

A cholesteric liquid crystal film with a first phase retardation film (¼ wavelength plate) formed on the upper surface thereof was provided. A liquid crystal material (second phase retardation film) was then coated on the lower surface of the cholesteric liquid crystal film by a spin coater (coating speed of 600 rpm). The thickness of the second phase retardation film was 2 μm. The liquid crystal material (type: RMS-015) was purchased from Merck Co., Ltd. The cholesteric liquid crystal film (type: HELISOL) was purchased from Wacker Co., Ltd. The second phase retardation film was then solidified by UV radiation in an exposure machine (temperature of 25° C., exposure time of 10 second). An optical device (with cholesteric liquid crystal film/liquid crystal material) of Example 1 was then fabricated.

Fabrication of the Backlight Module

The optical device was further combined with a backlight source and a reflector to fabricate a backlight module.

Color Variation Test

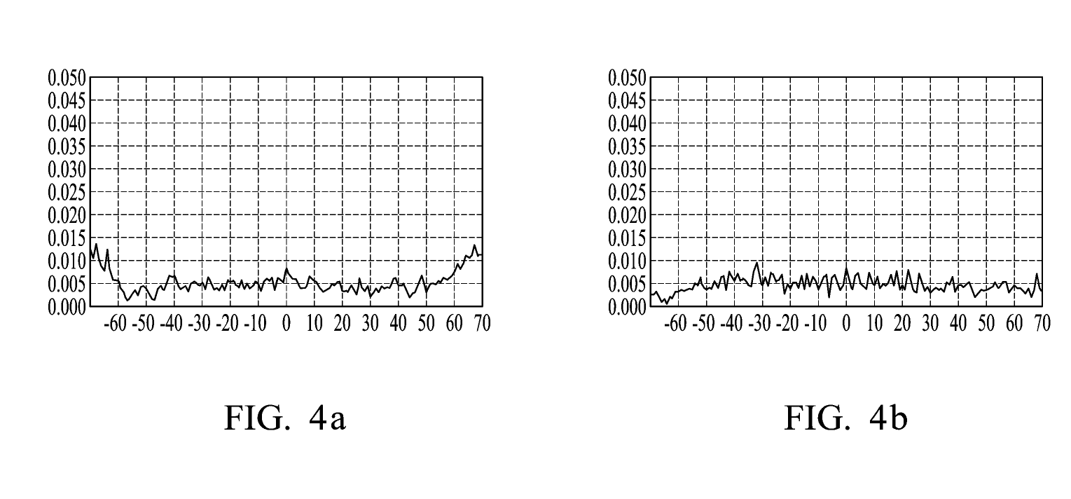

The color variation of the optical device was measured by Eldim EZcontrast 160. The results were shown in FIG. 4a (observed from left and right viewing angles of 0°) and FIG. 4b (observed from upper and lower viewing angles of 90°).

### EXAMPLE 2

Fabrication of the Optical Device II and the Backlight Module Comprising the Same

Fabrication of the Optical Device II

A cholesteric liquid crystal film with a first phase retardation film (¼ wavelength plate) formed on the upper surface thereof was provided. A liquid crystal material (second phase retardation film) was then coated on the lower surface of the cholesteric liquid crystal film by a spin coater (coating speed of 500 rpm). The thickness of the second phase retardation film was 3 μm. The liquid crystal material (type: RMS-015) was purchased from Merck Co., Ltd. The cholesteric liquid crystal film (type: HELISOL) was purchased from Wacker Co., Ltd. The second phase retardation film was then solidified by UV radiation in an exposure machine (temperature of 25° C., exposure time of 10 second). An optical device (with cholesteric liquid crystal film/liquid crystal material) of Example 2 was then fabricated.

Fabrication of the Backlight Module

The optical device was further combined with a backlight source and a reflector to fabricate a backlight module.

Color Variation Test

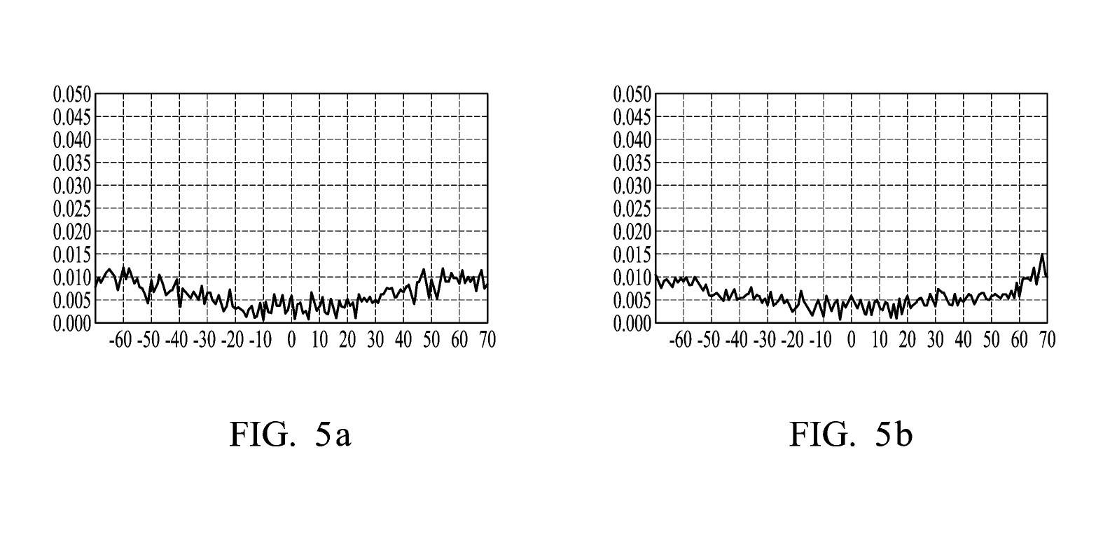

The color variation of the optical device was measured by Eldim EZcontrast 160. The results were shown in FIG. 5a (observed from left and right viewing angles of 0°) and FIG. 5b (observed from upper and lower viewing angles of 90°).

### EXAMPLE 3

Fabrication of the Optical Device III and the Backlight Module Comprising the Same

Fabrication of the Optical Device III

A cholesteric liquid crystal film with a first phase retardation film (¼ wavelength plate) formed on the upper surface thereof was provided. A liquid crystal material (o-plate) (second phase retardation film) was then pasted on the lower surface of the cholesteric liquid crystal film (the included angle between the liquid crystal material and the long axis of the cholesteric liquid crystal was 0°). The thickness of the second phase retardation film was 2 μm. The liquid crystal material (type: o-plate) was purchased from Far East Textile Co., Ltd. The cholesteric liquid crystal film (type: HELISOL) was purchased from Wacker Co., Ltd. An optical device (with cholesteric liquid crystal film/liquid crystal material (o-plate)) of Example 3 was then fabricated.

Fabrication of the Backlight Module

The optical device was further combined with a backlight source and a reflector to fabricate a backlight module.

Color Variation Test

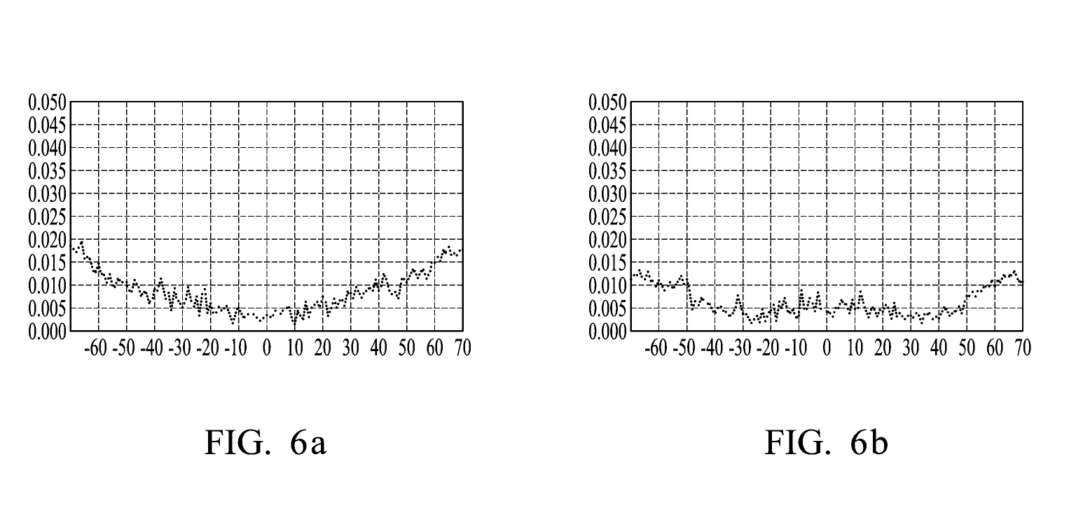

The color variation of the optical device was measured by Eldim EZcontrast 160. The results were shown in FIG. 6a (observed from left and right viewing angles of 0°) and FIG. 6b (observed from upper and lower viewing angles of 90°).

### EXAMPLE 4

Fabrication of the Optical Device IV and the Backlight Module Comprising the Same

Fabrication of the Optical Device IV

A cholesteric liquid crystal film with a first phase retardation film (¼ wavelength plate) formed on the upper surface thereof was provided. A first liquid crystal material (o-plate) was then pasted on the lower surface of the cholesteric liquid crystal film (the included angle between the first liquid crystal material and the long axis of the cholesteric liquid crystal was 0°). A second liquid crystal material (o-plate) was then pasted on the first liquid crystal material (the included angle between the second liquid crystal material and the long axis of the cholesteric liquid crystal was 0°). A second phase retardation film was formed by a combination of the first and second liquid crystal materials. The thickness of the second phase retardation film was 24 μm. The first and second liquid crystal materials (type: o-plate) were purchased from Far East Textile Co., Ltd. The cholesteric liquid crystal film (type: HELISOL) was purchased from Wacker Co., Ltd. An optical device (with cholesteric liquid crystal film/first liquid crystal material (o-plate)/second liquid crystal material (o-plate)) of Example 4 was then fabricated.

Fabrication of the Backlight Module

The optical device was further combined with a backlight source and a reflector to fabricate a backlight module.

Color Variation Test

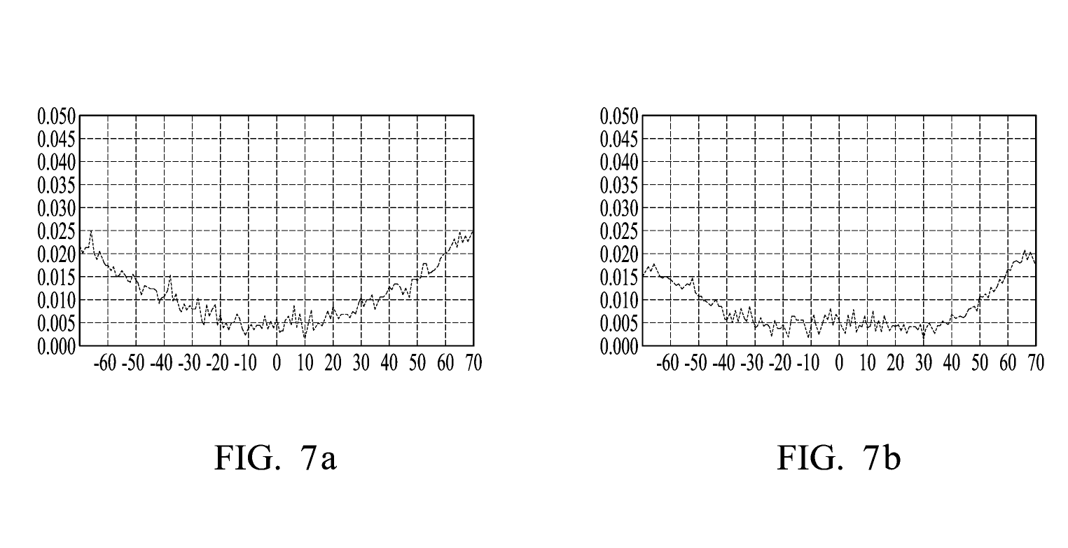

The color variation of the optical device was measured by Eldim EZcontrast 160. The results were shown in FIG. 7a (observed from left and right viewing angles of 0°) and FIG. 7b (observed from upper and lower viewing angles of 90°).

### EXAMPLE 5

Fabrication of the Optical Device V and the backlight Module Comprising the Same

Fabrication of the Optical Device V

A cholesteric liquid crystal film with a first phase retardation film (¼ wavelength plate) formed on the upper surface thereof was provided. A liquid crystal material (o-plate) (second phase retardation film) was then pasted on the lower surface of the cholesteric liquid crystal film (the included angle between the liquid crystal material and the long axis of the cholesteric liquid crystal was 90°). The thickness of the second phase retardation film was 2 μm. The liquid crystal material (type: o-plate) was purchased from Far East Textile Co., Ltd. The cholesteric liquid crystal film (type: HELISOL) was purchased from Wacker Co., Ltd. An optical device (with cholesteric liquid crystal film/liquid crystal material (o-plate)) of Example 5 was then fabricated.

Fabrication of the Backlight Module

The optical device was further combined with a backlight source and a reflector to fabricate a backlight module.

Color Variation Test

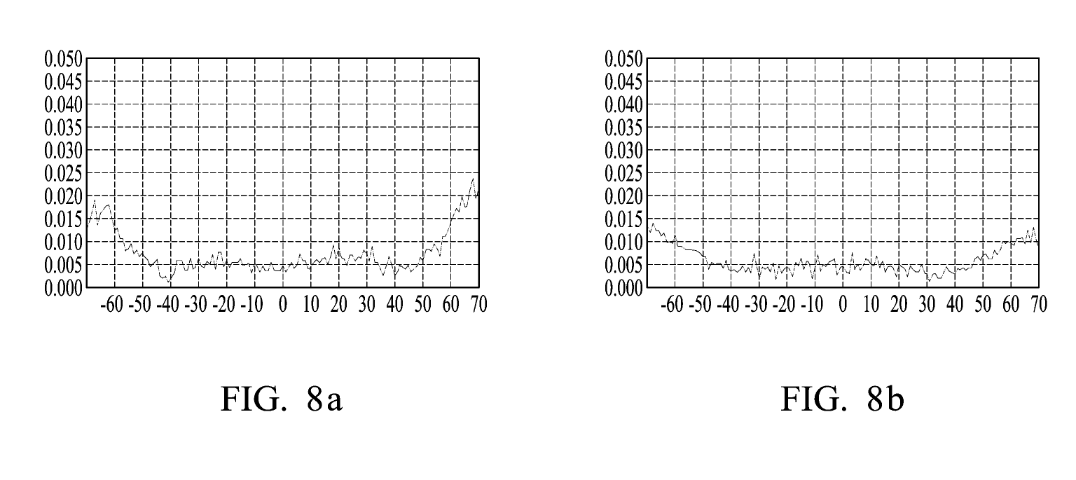

The color variation of the optical device was measured by Eldim EZcontrast 160. The results were shown in FIG. 8a (observed from left and right viewing angles of 0°) and FIG. 8b (observed from upper and lower viewing angles of 90°).

### EXAMPLE 6

Fabrication of the Optical Device VI and the Backlight Module Comprising the Same

Fabrication of the Optical Device VI

A cholesteric liquid crystal film with a first phase retardation film (¼ wavelength plate) formed on the upper surface thereof was provided. A first liquid crystal material (o-plate) was then pasted on the lower surface of the cholesteric liquid crystal film (the included angle between the first liquid crystal material and the long axis of the cholesteric liquid crystal was 90°). A second liquid crystal material (o-plate) was then pasted on the first liquid crystal material (the included angle between the second liquid crystal material and the long axis of the cholesteric liquid crystal was 90°). A second phase retardation film was formed by combination of the first and second liquid crystal materials. The thickness of the second phase retardation film was 24 μm. The first and second liquid crystal materials (type: o-plate) were purchased from Far East Textile Co., Ltd. The cholesteric liquid crystal film (type: HELISOL) was purchased from Wacker Co., Ltd. An optical device (with cholesteric liquid crystal film/first liquid crystal material (o-plate)/second liquid crystal material (o-plate)) of Example 6 was then fabricated.

Fabrication of the Backlight Module

The optical device was further combined with a backlight source and a reflector to fabricate a backlight module.

Color Variation Test

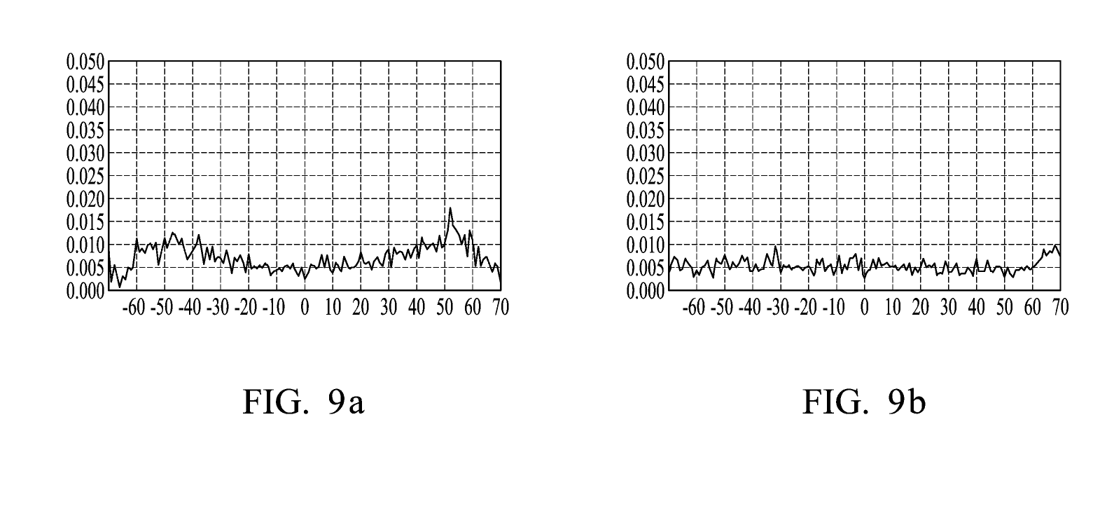

The color variation of the optical device was measured by Eldim EZcontrast 160. The results were shown in FIG. 9a (observed from left and right viewing angles of 0°) and FIG. 9b (observed from upper and lower viewing angles of 90°).

### EXAMPLE 7

Fabrication of the Optical Device VII and the Backlight Module Comprising the Same

Fabrication of the Optical Device VII

A cholesteric liquid crystal film with a first phase retardation film (¼ wavelength plate) formed on the upper surface thereof was provided. A liquid crystal material (o-plate) (second phase retardation film) was then pasted on the lower surface of the cholesteric liquid crystal film (the included angle between the liquid crystal material and the long axis of the cholesteric liquid crystal was 45°). The thickness of the second phase retardation film was 2 μm. The liquid crystal material (type: o-plate) was purchased from Far East Textile Co., Ltd. The cholesteric liquid crystal film (type: HELISOL) was purchased from Wacker Co., Ltd. An optical device (with cholesteric liquid crystal film/liquid crystal material (o-plate)) of Example 7 was then fabricated.

Fabrication of the Backlight Module

The optical device was further combined with a backlight source and a reflector to fabricate a backlight module.

Color Variation Test

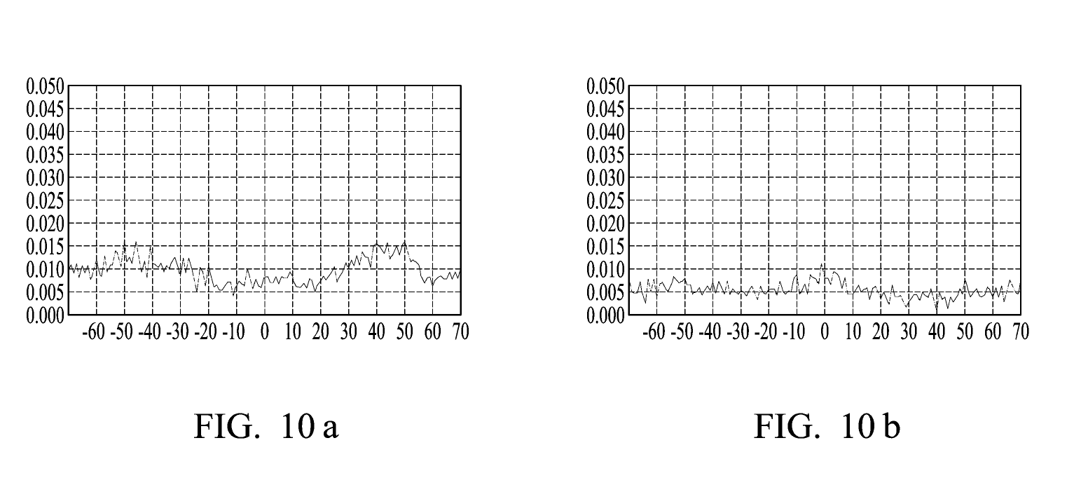

The color variation of the optical device was measured by Eldim EZcontrast 160. The results were shown in FIG. 10a (observed from left and right viewing angles of 0°) and FIG. 10b (observed from an upper and lower viewing angles of 90°).

### EXAMPLE 8

Fabrication of the Optical Device VIII and the Backlight Module Comprising the Same

Fabrication of the Optical Device VIII

A cholesteric liquid crystal film with a first phase retardation film (¼ wavelength plate) formed on the upper surface thereof was provided. A first liquid crystal material (o-plate) was then pasted on the lower surface of the cholesteric liquid crystal film (the included angle between the first liquid crystal material and the long axis of the cholesteric liquid crystal was 45°). A second liquid crystal material (o-plate) was then pasted on the first liquid crystal material (the included angle between the second liquid crystal material and the long axis of the cholesteric liquid crystal was 45°). A second phase retardation film was formed by combination of the first and second liquid crystal materials. The thickness of the second phase retardation film was 24 μm. The first and second liquid crystal materials (type: o-plate) were purchased from Far East Textile Co., Ltd. The cholesteric liquid crystal film (type: HELISOL) was purchased from Wacker Co., Ltd. An optical device (with cholesteric liquid crystal film/first liquid crystal material (o-plate)/second liquid crystal material (o-plate)) of Example 8 was then fabricated.

Fabrication of the Backlight Module

The optical device was further combined with a backlight source and a reflector to fabricate a backlight module.

Color Variation Test

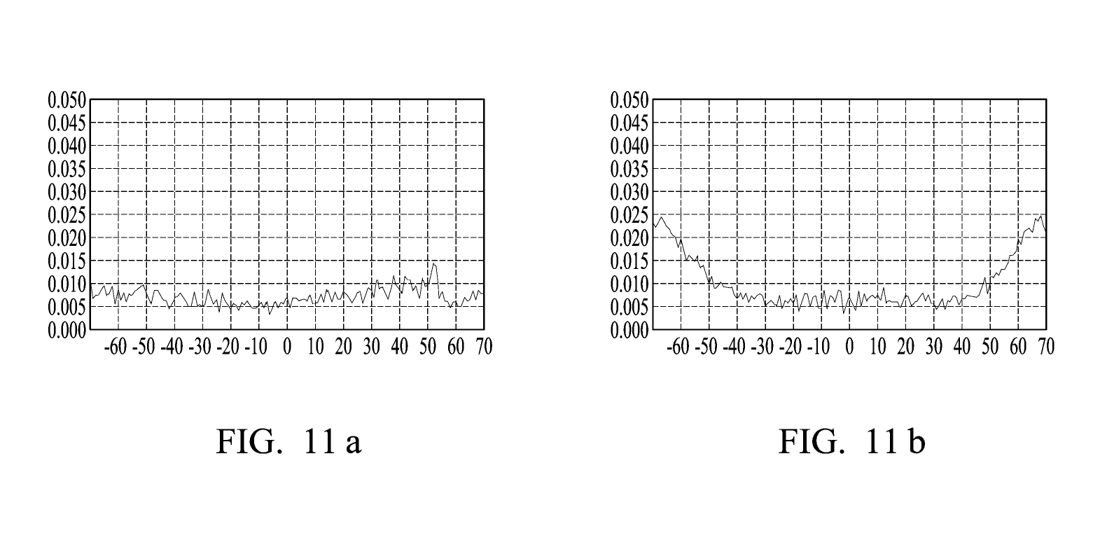

The color variation of the optical device was measured by Eldim EZcontrast 160. The results were shown in FIG. 11a (observed from left and right viewing angles of 0°) and FIG. 11b (observed from upper and lower viewing angles of 90°).

### EXAMPLE 9

Fabrication of the Optical Device IX and the Backlight Module Comprising The Same

Fabrication of the Optical Device IX

A cholesteric liquid crystal film with a first phase retardation film (¼ wavelength plate) formed on the upper surface thereof was provided. A first liquid crystal material (o-plate) was then pasted on the lower surface of the cholesteric liquid crystal film (the included angle between the first liquid crystal material and the long axis of the cholesteric liquid crystal was 45°). A second liquid crystal material (o-plate) was then pasted on the first liquid crystal material (the included angle between the second liquid crystal material and the long axis of the cholesteric liquid crystal was 45°). A third liquid crystal material (o-plate) was then pasted on the second liquid crystal material (the included angle between the third liquid crystal material and the long axis of the cholesteric liquid crystal was 45°). A second phase retardation film was formed by a combination of the first, second and third liquid crystal materials. The thickness of the second phase retardation film was 46 μm. The first, second and third liquid crystal materials (type: o-plate) were purchased from Far East Textile Co., Ltd. The cholesteric liquid crystal film (type: HELISOL) was purchased from Wacker Co., Ltd. An optical device (with cholesteric liquid crystal film/first liquid crystal material (o-plate)/second liquid crystal material (o-plate)/third liquid crystal material (o-plate)) of Example 9 was then fabricated.

Fabrication of the Backlight Module

The optical device was further combined with a backlight source and a reflector to fabricate a backlight module.

Color Variation Test

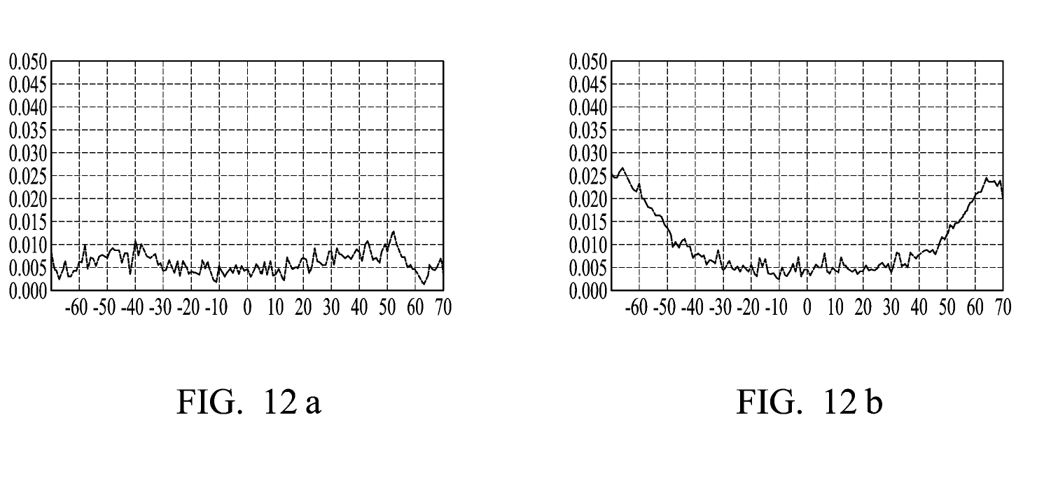

The color variation of the optical device was measured by Eldim EZcontrast 160. The results were shown in FIG. 12a (observed from left and right viewing angles of 0°) and FIG. 12b (observed from upper and lower viewing angles of 90°).

### EXAMPLE 10

Fabrication of the Optical Device X and The Backlight Module Comprising the Same

Fabrication of the Optical Device X

A cholesteric liquid crystal film with a first phase retardation film (¼ wavelength plate) formed on the upper surface thereof was provided. A first liquid crystal material (o-plate) was then pasted on the lower surface of the cholesteric liquid crystal film (the included angle between the first liquid crystal material and the long axis of the cholesteric liquid crystal was 0°). A second liquid crystal material (o-plate) was then pasted on the first liquid crystal material (the included angle between the second liquid crystal material and the long axis of the cholesteric liquid crystal was 30°). A second phase retardation film was formed by a combination of the first and second liquid crystal materials. The thickness of the second phase retardation film was 24 μm. The first and second liquid crystal materials (type: o-plate) were purchased from Far East Textile Co., Ltd. The cholesteric liquid crystal film (type: HELISOL) was purchased from Wacker Co., Ltd. An optical device (with cholesteric liquid crystal film/first liquid crystal material (o-plate)/second liquid crystal material (o-plate)) of Example 10 was then fabricated.

Fabrication of the Backlight Module

The optical device was further combined with a backlight source and a reflector to fabricate a backlight module.

Color Variation Test

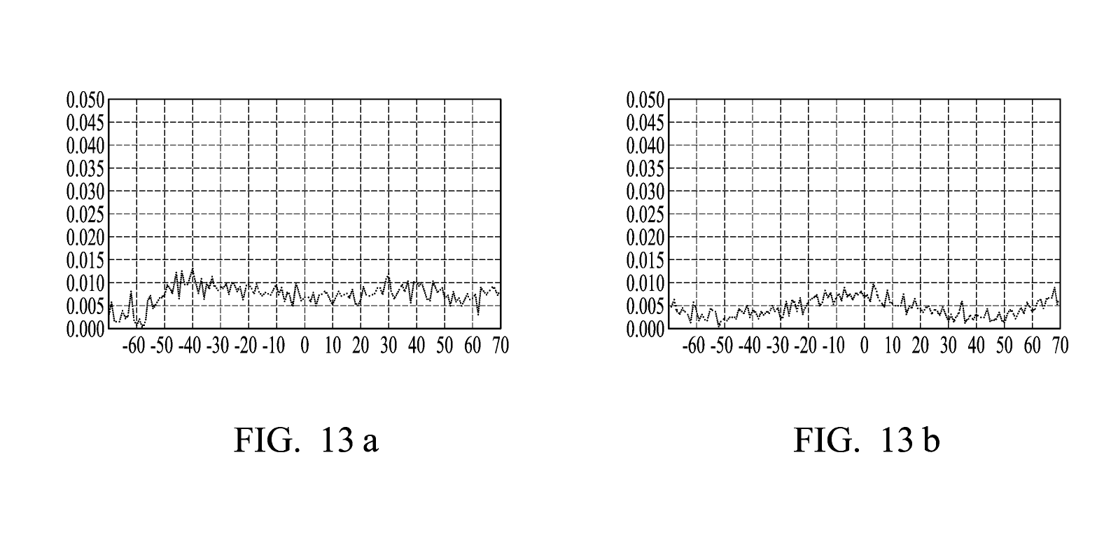

The color variation of the optical device was measured by Eldim EZcontrast 160. The results were shown in FIG. 13a (observed from left and right viewing angles of 0°) and FIG. 13b (observed from upper and lower viewing angles of 90°).

### COMPARATIVE EXAMPLE 1

Fabrication of the Optical Device XI and the Backlight Module Comprising the Same

Fabrication of the Optical Device XI

A cholesteric liquid crystal film with a first phase retardation film (¼ wavelength plate) formed on the upper surface thereof was provided. The cholesteric liquid crystal film (type: HELISOL) was purchased from Wacker Co., Ltd. An optical device (with cholesteric liquid crystal film) of Comparative Example 1 was then fabricated.

Fabrication of the Backlight Module

The optical device was further combined with a backlight source and a reflector to fabricate a backlight module.

Color Variation Test

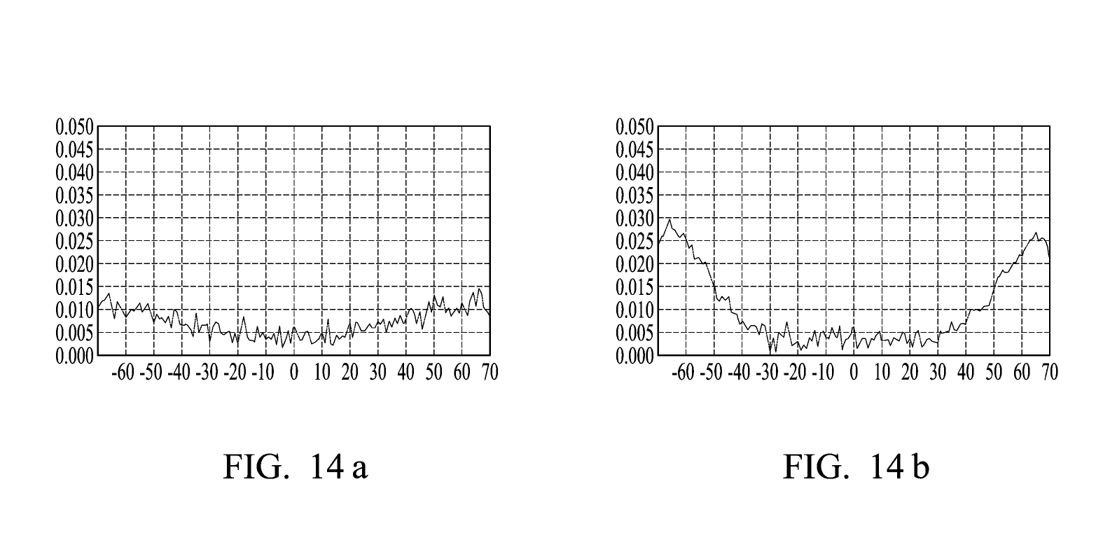

The color variation of the optical device was measured by Eldim EZcontrast 160. The results were shown in FIG. 14a (observed from left and right viewing angles of 0°) and FIG. 14b (observed from upper and lower viewing angles of 90°).

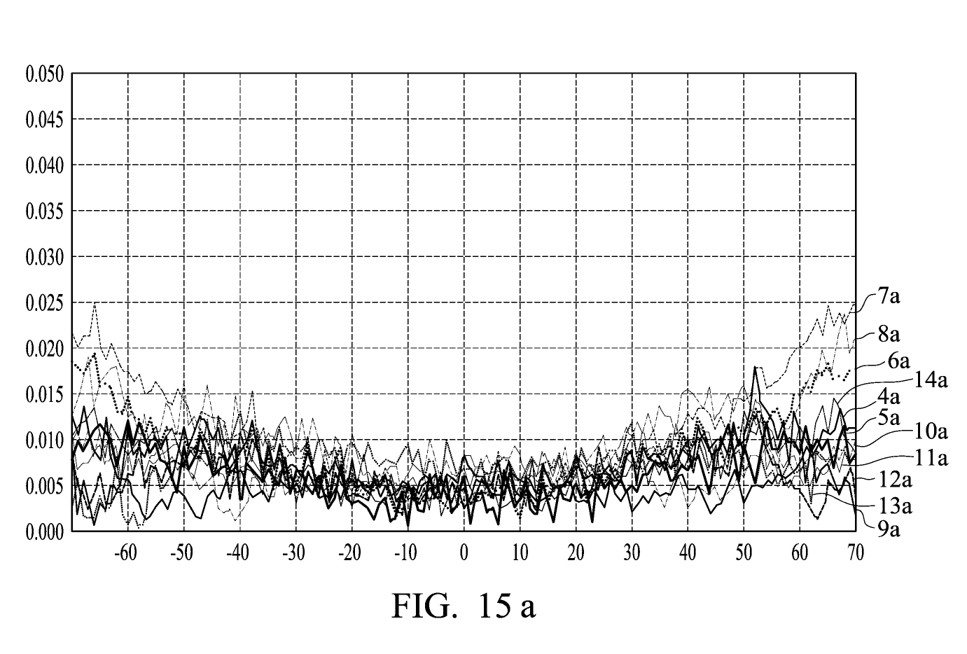

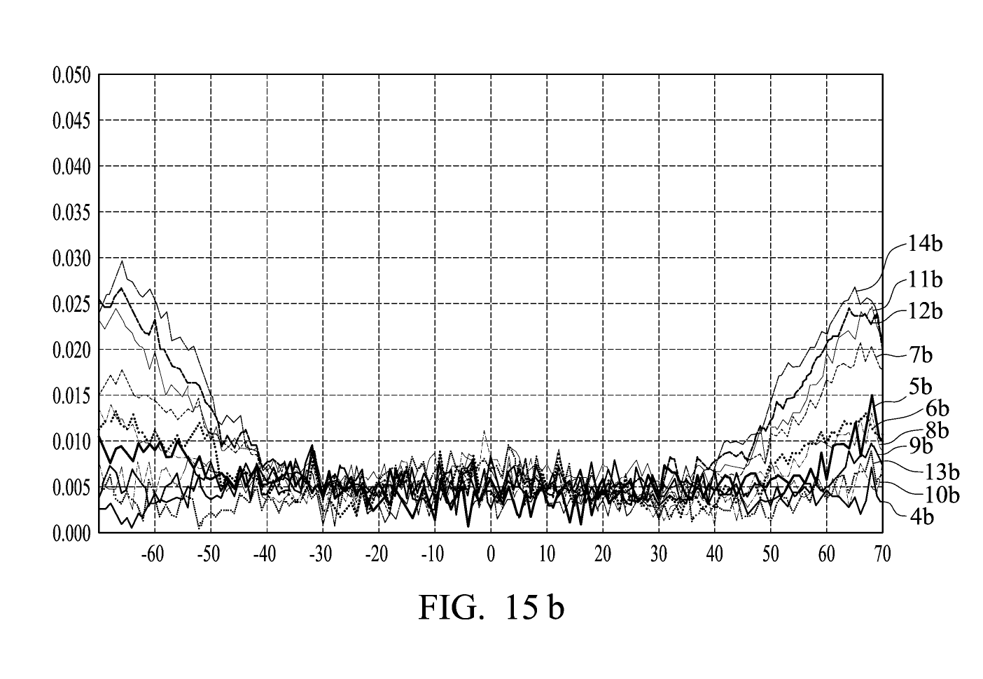

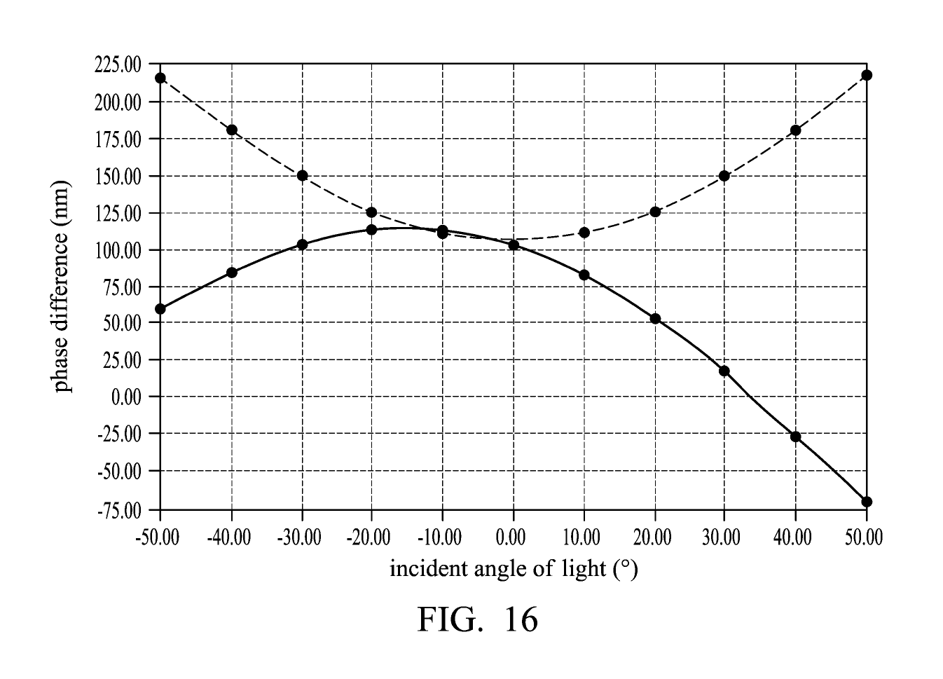

FIG. 15a shows a comparison of color variation between the disclosed optical devices (FIG. 4a to FIG. 13a) and a conventional optical device (FIG. 14a). FIG. 15b shows a comparison of color variation between the disclosed optical devices (FIG. 4b to FIG. 13b) and a conventional optical device (FIG. 14b). Compared to the conventional backlight module composed of the optical device merely with the cholesteric liquid crystal film, the color variation (respectively observed from left and right viewing angles of 0° (FIG. 15a) and from upper and lower viewing angles of 90° (FIG. 15b)) of the disclosed backlight module composed of the optical device with the cholesteric liquid crystal film and the second phase retardation film was apparently improved.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A low color variation optical device, comprising:
a cholesteric liquid crystal film;
a first phase retardation film disposed above the cholesteric liquid crystal film; and
a second phase retardation film disposed below the cholesteric liquid crystal film, wherein the second phase retardation film comprises a plurality of molecules with a tilted and twisted arrangement.

2. The low color variation optical device as claimed in claim 1, wherein the first phase retardation film has a plane phase difference of 100-210 nm.

3. The low color variation optical device as claimed in claim 1, wherein the first phase retardation film is a ¼ wavelength phase retardation film.

4. The low color variation optical device as claimed in claim 1, wherein the plurality of molecules comprises liquid crystal molecules or monomers.

5. The low color variation optical device as claimed in claim 1, wherein the plurality of molecules with the tilted and twisted arrangement has a tilted angle of 1-89°.

6. The low color variation optical device as claimed in claim 1, wherein the plurality of molecules with the tilted and twisted arrangement has a tilted angle of 1-45°.

7. The low color variation optical device as claimed in claim 1, wherein the plurality of molecules with the tilted and twisted arrangement has a twisted angle of 1-360°.

8. The low color variation optical device as claimed in claim 1, wherein the plurality of molecules with the tilted and twisted arrangement has a twisted angle of 1-90°.

9. The low color variation optical device as claimed in claim 1, wherein the second phase retardation film has an optical configuration comprising a-plate, c-plate or o-plate.

10. The low color variation optical device as claimed in claim 1, wherein the second phase retardation film has a thickness of 0.1-20 μtm.

11. The low color variation optical device as claimed in claim 1, wherein the second phase retardation film is directly in contact with the cholesteric liquid crystal film.

12. The low color variation optical device as claimed in claim 1, further comprising an optical gel layer formed between the second phase retardation film and the cholesteric liquid crystal film.

13. A backlight module, comprising:
a light source;
a light guide plate disposed on one side of the light source;
a reflector disposed below the light guide plate;
an optical device disposed above the light guide plate; and
a polarizer disposed above the optical device, wherein the optical device comprises a cholesteric liquid crystal film, a first phase retardation film disposed above the cholesteric liquid crystal film and a second phase retardation film disposed below the cholesteric liquid crystal film, wherein the second phase retardation film comprises a plurality of molecules with a tilted and twisted arrangement.

14. The backlight module as claimed in claim 13, wherein the light source comprises cold cathode fluorescent lamps (CCFL) or light-emitting diodes.

15. The backlight module as claimed in claim 13, wherein the polarizer is an absorptive polarizer.

16. The backlight module as claimed in claim 13, wherein the backlight module is an edge-lighting backlight module.

17. A backlight module, comprising:
a light source;
a reflector disposed above the light source;
an optical device disposed above the reflector; and
a polarizer disposed above the optical device, wherein the optical device comprises a cholesteric liquid crystal film, a first phase retardation film disposed above the cholesteric liquid crystal film and a second phase retardation film disposed below the cholesteric liquid crystal film, wherein the second phase retardation film comprises a plurality of molecules with a tilted and twisted arrangement.

18. The backlight module as claimed in claim 17, wherein the light source comprises cold cathode fluorescent lamps (CCFL) or light-emitting diodes.

19. The backlight module as claimed in claim 17, wherein the polarizer is an absorptive polarizer.

20. The backlight module as claimed in claim 17, wherein the backlight module is a bottom-lighting backlight module.

21. A liquid crystal display, comprising:
a liquid crystal display panel; and
a backlight module as claimed in claim 13 disposed below the liquid crystal display panel.

22. A liquid crystal display, comprising:
a liquid crystal display panel; and
a backlight module as claimed in claim 17 disposed below the liquid crystal display panel.
